(19) United States
(12) Patent Application Publication
(10) Pub. No.: US 2026/0332214 A1
(43) Pub. Date: Oct. 22, 2026

(54) INFORMATION SENDING METHOD AND APPARATUS, INFORMATION RECEIVING METHOD AND APPARATUS, AND COMMUNICATION APPARATUS AND STORAGE MEDIUM

(71) Applicant: Beijing Xiaomi Mobile Software Co., Ltd., Beijing (CN)

(72) Inventors: Xueyuan GAO, Beijing (CN); Min LIU, Beijing (CN); Hua ZHOU, Beijing (CN); Zhongyuan ZHAO, Beijing (CN)

(73) Assignee: Beijing Xiaomi Mobile Software Co., Ltd., Beijing (CN)

(21) Appl. No.: 19/116,893

(22) PCT Filed: Sep. 30, 2022
(86) PCT No.: PCT/CN2022/123622

§ 371 Date: Mar. 28, 2025

(51) Int. Cl. H04B 7/06

(52) U.S. Cl. CPC H04B 7/0626

(57) ABSTRACT

The present disclosure relates to an information sending method and apparatus, an information receiving method and apparatus, and a communication apparatus and a storage medium. The information sending method comprises: preprocessing estimated full-channel information according to a first number of spatial-domain basis vectors and a second number of frequency-domain basis vectors, so as to obtain effective channel information; calculating a feature vector of the effective channel information; and inputting the feature vector into a model, so as to obtain CSI-related information, and sending the CSI-related information to a network device.

### CROSS-REFERENCE TO RELATED APPLICATIONS

This application is a national stage of International Application No. PCT/CN2022/123622, filed on Sep. 30, 2022, which is hereby incorporated by reference in its entirety.

### TECHNICAL FIELD

The present disclosure relates to the field of communication technologies, and in particular, to an information sending method, an information receiving method, an information sending apparatus, an information receiving apparatus, a communication apparatus and a computer readable storage medium.

### BACKGROUND

A terminal may report channel state information (CSI) to a network device, so that the network device determines a current channel state, and then performs proper configuration to ensure a good communication effect.

To reduce CSI reporting overheads and improve CSI reporting accuracy, a bilateral model for determining a CSI generation part and a CSI recovery part based on artificial intelligence (AI)/machine learning (ML) is proposed in related arts to achieve this purpose.

However, the input of the model in related arts is the data related to the number of antenna ports, and if this data is used as the input of the model, different models need to be trained for scenarios of different number of antenna ports, leading to a large number of models to be configured for the terminal, which increases signaling overheads and occupies too much storage space of the terminal.

### SUMMARY

In view of this, embodiments of the present disclosure provide an information sending method, an information receiving method, an information sending apparatus, an information receiving apparatus, a communication apparatus, and a computer-readable storage medium, to resolve a technical problem in the related art.

According to a first aspect of the embodiments of the present disclosure, an information sending method is provided, performed by a terminal, including: pre-processing estimated downlink full channel information according to a first number of spatial-domain basis vectors and a second number of frequency-domain basis vectors to obtain effective channel information; calculating an eigenvector of the effective channel information; and inputting the eigenvector into a first artificial intelligence and/or machine learning model to obtain channel state information (CSI)-related information, and sending the CSI-related information to a network device.

According to a second aspect of the embodiments of the present disclosure, an information receiving method is provided, performed by a network device, including: receiving CSI-related information sent by a terminal according to the above information sending method.

According to a third aspect of the embodiments of the present disclosure, an information sending apparatus is provided, including: a processing module, configured to pre-process estimated downlink full channel information according to a first number of spatial-domain basis vectors and a second number of frequency-domain basis vectors to obtain effective channel information; calculating an eigenvector of the effective channel information; and input the eigenvector into a first artificial intelligence and/or machine learning model to obtain channel state information (CSI)-related information; and a sending module, configured to send the CSI-related information to a network device.

According to a fourth aspect of the embodiments of the present disclosure, an information receiving apparatus is provided, including: a receiving module, configured to receive CSI-related information sent by a terminal according to the above information sending method.

According to a fifth aspect of the embodiments of the present disclosure, an information transceiving system is provided, including a terminal and a network device, where the terminal is configured to implement the above information sending method, and the network device is configured to implement the above information receiving method.

According to a sixth aspect of the embodiments of the present disclosure, a communication apparatus is provided, including: a processor; and a memory configured to store a computer program, where the computer program, when executed by the processor, implements the above information sending method.

According to a seventh aspect of the embodiments of the present disclosure, a communication apparatus is provided, including: a processor; and a memory configured to store a computer program, where the computer program, when executed by the processor, implements the above information receiving method.

According to an eighth aspect of the embodiments of the present disclosure, a computer-readable storage medium is provided, configured to store a computer program, where the computer program, when executed by a processor, implements the above information sending method.

According to a ninth aspect of the embodiments of the present disclosure, a computer-readable storage medium is provided, configured to store a computer program, where the computer program, when executed by a processor, implements the above information receiving method.

According to the embodiments of the present disclosure, the eigenvector of the effective channel information can be further calculated, for example, the eigenvector is obtained by performing eigenvalue analysis on the effective channel information, and dimensions of the eigenvector is irrelevant to a number Nr of receiving antenna ports. Therefore, the eigenvector is used as an input of a first artificial intelligence model and/or a machine learning model, and it is not necessary to train different models by means of taking into account scenarios with different numbers of receiving antenna ports, thereby facilitating a reduction in the number of models that are required to be trained, that is, reducing the number of models that are required to be sent to a terminal and the number of models that are required to be stored in the terminal, and thus facilitating a reduction in signaling overheads and saving on storage space of the terminal.

### BRIEF DESCRIPTION OF DRAWINGS

In order to more clearly illustrate the technical solutions in the embodiments of the present disclosure, the accompanying drawings required in the description of the embodiments will be briefly described below, obviously, the accompanying drawings in the following description are only some embodiments of the present disclosure, and for those skilled in the art, other accompanying drawings may also be obtained according to these accompanying drawings without making creative efforts.

FIG. 1 is a schematic diagram of an application scenario according to an embodiment of the present disclosure.

FIG. 2 is a schematic flowchart of an information sending method according to an embodiment of the present disclosure.

FIG. 3 is a schematic flowchart of another information sending method according to an embodiment of the present disclosure.

FIG. 4 is a schematic flowchart of another information sending method according to an embodiment of the present disclosure.

FIG. 5 is a schematic flowchart of another information sending method according to an embodiment of the present disclosure.

FIG. 6 is a schematic flowchart of an information receiving method according to an embodiment of the present disclosure.

FIG. 7 is a schematic block diagram of an information sending apparatus according to an embodiment of the present disclosure.

FIG. 8 is a schematic block diagram of an information receiving apparatus according to an embodiment of the present disclosure.

FIG. 9 is a schematic block diagram of an apparatus for receiving information according to an embodiment of the present disclosure.

FIG. 10 is a schematic block diagram of an apparatus for sending information according to an embodiment of the present disclosure.

### DETAILED DESCRIPTION

The technical solutions in the embodiments of the present disclosure will be clearly and completely described below with reference to the accompanying drawings in the embodiments of the present disclosure, and obviously, the described embodiments are only some but not all of the embodiments of the present disclosure. Based on the embodiments in the present disclosure, all other embodiments obtained by those skilled in the art without making creative efforts fall within the protection scope of the present disclosure.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first”, “second”, “third”, etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on context, the word “if” as used herein may be interpreted as “when” or “upon” or “in response to determining”.

For purposes of brevity and ease of understanding, the terms used herein for describing magnitude relationship are “greater than” or “less than”, “above” or “below”. However, those skilled in the art may understand that the term “greater than” also covers the meaning of “greater than or equal to”, and “less than” also covers the meaning of “less than or equal to”; the term “higher than” covers the meaning of “higher than or equal to”, and “lower than” also covers the meaning of “lower than or equal to”.

A terminal may report channel state information (CSI) to a network device, so that the network device determines a current channel state, and then performs proper configuration to ensure a good communication effect.

To reduce CSI reporting overheads and improve CSI reporting accuracy, a bilateral model for determining a CSI generation part and a CSI recovery part based on artificial intelligence (AI)/machine learning (ML) is proposed in related arts to achieve this purpose.

However, the input of the model in related arts is the data related to the number of antenna ports, and if the data is used as the input of the model, different models need to be trained for scenarios of different number of antenna ports, leading to a large number of models to be configured for the terminal, which increases signaling overheads and occupies too much storage space of the terminal.

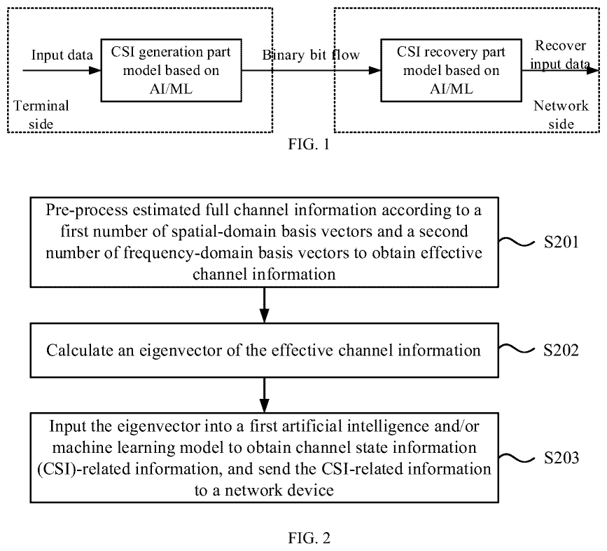

FIG. 1 is a schematic diagram of an application scenario according to an embodiment of the present disclosure.

As shown in FIG. 1, an AI/ML-based CSI generation part model is set on a terminal, and an AI/ML-based CSI recovery part model is set on a network device.

The terminal determines input data by detecting downlink channel information sent by the network device, inputs the input data into the CSI generation part model, and the CSI generation part model may compress the input data, quantifies the compressed data (for example, obtain a binary bit flow) and sends to the network device.

The network device receives the quantified data from the terminal and inputs into the CSI recovery part model, and the CSI recovery part model may recover the quantified data to obtain recovered input data, for example, CSI-related information.

However, a dimension of input data determined by the terminal is related to a transmit antenna (a network side antenna) port configuration of the network device and a number of frequency-domain units, where different CSI generation part models need to be trained for different transmit antenna port configurations, the CSI generation part models need to be configured by the network device to the terminal, and the terminal needs to store the CSI generation part models, and an excessive number of CSI generation part models will lead to increased signaling overheads, and occupy storage space of the terminal.

In respect of the above problem, the input data can be pre-processed through spatial-domain basis (SD basis) vectors and frequency-domain basis (FD basis) vectors of discrete Fourier transform (DFT) to obtain main feature information of a channel, and information obtained after pre-processing is unrelated to a transmit antenna port configuration and a number of frequency-domain units, to help reduce a number of CSI generation part models that need to be trained.

However, on one hand, although the dimension of the information obtained by pre-processing by using the SD basis and the FD basis of the DFT is unrelated to the configuration of the transmit antenna port, the dimension of the information is related to the number of receiving antenna (terminal side antenna) ports, and different CSI generation part models still need to be trained for different number of receiving antenna ports, the problem of excessive number of CSI generation part models to be trained still exists.

On the other hand, as both the SD basis and the FD basis are DFT basis (discrete Fourier transform basis vectors), information obtained by pre-processing the SD basis and the FD basis has a DFT codebook characteristic, and due to a quantification characteristic of the DFT codebook, when a CSI recovery part model recovers quantified data, there will be much information loss, which affects a determination of a downlink channel state by a network device.

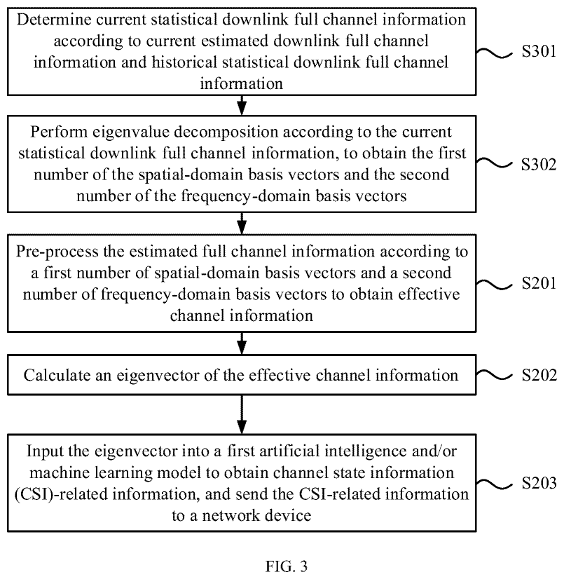

FIG. 2 is a schematic flowchart of an information sending method according to an embodiment of the present disclosure. The information sending method shown in this embodiment may be performed by a terminal, where the terminal includes but is not limited to a communication apparatus such as a mobile phone, a tablet computer, a wearable device, a sensor, and an Internet of Things device. The terminal may communicate with a network device, and the network device includes but is not limited to a network device such as a base station or a core network in any generation of communication system such as 4G, 5G, and 6G.

As shown in FIG. 2, the information sending method may include following steps.

In step S201, pre-processing estimated downlink full channel information according to a first number of spatial-domain basis vectors and a second number of frequency-domain basis vectors to obtain effective channel information.

In step S202, calculating an eigenvector of the effective channel information.

In step S203, inputting the eigenvector into a first artificial intelligence and/or machine learning model to obtain channel state information (CSI)-related information, and sending the CSI-related information to a network device.

In an embodiment, the terminal may receive a downlink state information reference signal (CSI-RS) sent by the network device, and determine the estimated downlink full channel information based on the CSI-RS, where the estimated downlink full channel information includes at least spatial-domain channel information and frequency-domain channel information.

Further, spatial-domain basis vectors and frequency-domain basis vectors may be determined according to the estimated downlink full channel information, and how to determine the spatial-domain basis vectors and the frequency-domain basis vectors is described in subsequent embodiments.

Next, the estimated downlink full channel information may be pre-processed based on the first number of spatial-domain basis vectors and the second number of frequency-domain basis vectors (a manner for pre-processing can be referred from related technologies, and details will not be described in the present disclosure) to obtain the effective channel information, and a dimension of the effective channel information is determined based on the number of receiving antenna ports of the terminal, the first number, and the second number.

For example, when the terminal communicates by using a dual-polarized antenna, the first number is L, the second number is M, and the number of receiving antenna ports is Nr, a dimension of the effective channel information is equal to 2 times of a product of Nr and L and M, that is, Nr×2 LM. It can be learned that a dimension of the effective channel information is related to the number Nr of receiving antenna ports.

According to the embodiments of the present disclosure, the eigenvector of the effective channel information can be further calculated, for example, the eigenvector is obtained by performing eigenvalue analysis on the effective channel information, and dimensions of the eigenvector is irrelevant to a number Nr of receiving antenna ports. Therefore, the eigenvector is used as an input of a first artificial intelligence model and/or a machine learning model (for example, the above mentioned CSI generation part model), and it is not necessary to train different models by means of taking into account scenarios with different numbers of receiving antenna ports, thereby facilitating a reduction in the number of models that are required to be trained, that is, reducing the number of models that are required to be sent to a terminal and the number of models that are required to be stored in the terminal, and thus facilitating a reduction in signaling overheads and saving on storage space of the terminal. In all embodiments of the present disclosure, the first number L and the second number M may be same or different, which is not limited in the embodiments of the present disclosure.

FIG. 3 is a schematic flowchart of another information sending method according to an embodiment of the present disclosure. As shown in FIG. 3, the method further includes following steps.

In step S301, determining current statistical downlink full channel information according to the current estimated downlink full channel information and historical statistical downlink full channel information.

In step S302, performing eigenvalue decomposition according to the current statistical downlink full channel information, to obtain the first number of the spatial-domain basis vectors and the second number of the frequency-domain basis vectors.

Where a type of the spatial-domain basis vectors and the frequency-domain basis vectors is an eigenvector.

In an embodiment, for example, a current time point is t, and a historical time point, for example, t−1, refers to any time point before the current time point, current estimated downlink full channel information may be denoted as Hₜ, historical statistical downlink full channel information may be denoted as Hₜ₋₁′, and current statistical downlink full channel information may be denoted as Hₜ′. In an example, Hₜ′ can be calculated by using a filtering algorithm with α<1, for example, Hₜ′=αHₜ+(1−α)Hₜ₋₁′.

Further, eigenvalue decomposition is performed according to the current statistical downlink full channel information, for example, a transposed matrix

$${( {H}_{t}^{′} )}^{H}$$

of

$${H}_{t}^{′}$$

may be determined first, then eigenvalue decomposition is performed on

$${( {H}_{t}^{′} )}^{H} {H}_{t}^{′}$$

to obtain a plurality of eigenvectors, and a first number of eigenvectors with largest eigenvalues are selected from the plurality of eigenvectors as the first number of spatial-domain basis vectors; similarly, eigenvalue decomposition may be performed on

$${{H}_{t}^{′} ( {H}_{t}^{′} )}^{H}$$

to obtain a plurality of eigenvectors, and a second number of eigenvectors with largest eigenvalues are selected from the plurality of eigenvectors as the second number of frequency-domain basis vectors. The first number of spatial-domain basis vectors and the second number of frequency-domain basis vectors obtained are both eigenvectors.

On this basis, the terminal may pre-process the current statistical downlink full channel information by using the first number of spatial-domain basis vectors and the second number of frequency-domain basis vectors, to obtain effective channel information

$${H}_{t}^{eff} ,$$

where a dimension of

$${H}_{t}^{eff}$$

is Nr×2LM. In this embodiment, by further performing eigenvalue decomposition according to

$${H}_{t}^{eff} ,$$

for example, performing eigenvalue decomposition on

$${( {H}_{t}^{eff} )}^{H} {H}_{t}^{eff} or {{H}_{t}^{eff} ( {H}_{t}^{eff} )}^{H} ,$$

a plurality of eigenvectors are obtained, a dimension of the obtained eigenvectors are irrelevant to the number Nr of receiving antenna ports.

In addition, in this embodiment, as the type of the first number of spatial-domain basis vectors and the second number of frequency-domain basis vectors are both eigenvectors instead of DFT basis vectors, the effective channel information obtained by pre-processing the spatial-domain basis vectors and the frequency-domain basis vectors does not have a DFT codebook characteristic, and excessive information loss will not be caused for recovery of quantified data by the CSI recovery part model due to a quantification characteristic of the DFT codebook, which is beneficial to ensuring that the network device accurately recovers information reported by the terminal, so as to accurately determine a state of a downlink channel.

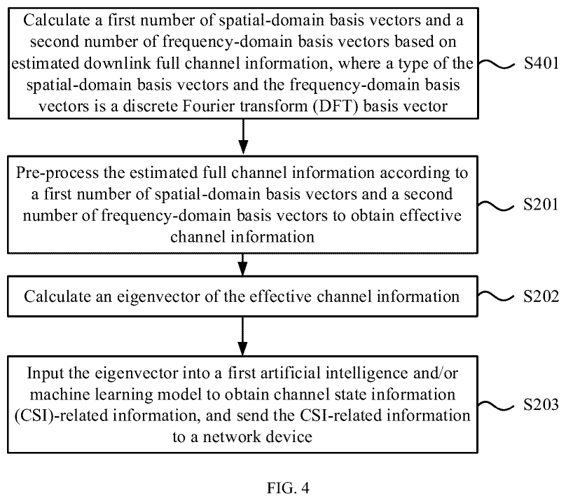

FIG. 4 is a schematic flowchart of another information sending method according to an embodiment of the present disclosure. As shown in FIG. 4, the method further includes following step.

In step S401, calculating the first number of the spatial-domain basis vectors and the second number of the frequency-domain basis vectors based on the estimated downlink full channel information, where a type of the spatial-domain basis vectors and the frequency-domain basis vectors is a discrete Fourier transform (DFT) basis vector.

In an embodiment, the terminal may calculate a first number of spatial-domain basis vectors and a second number of frequency-domain basis vectors of the DFT basis vector type based on the estimated downlink full channel information, and then pre-process the current statistical downlink full channel information based on the first number of spatial-domain basis vectors and the second number of frequency-domain basis vectors, to obtain effective channel information

$${H}_{t}^{eff} ,$$

where a dimension of

$${H}_{t}^{eff}$$

is Nr×2LM. In this embodiment, by further performing eigenvalue decomposition according to

$${H}_{t}^{eff} ,$$

for example, performing eigenvalue decomposition on

$${( {H}_{t}^{eff} )}^{H} {H}_{t}^{eff} or {{H}_{t}^{eff} ( {H}_{t}^{eff} )}^{H} ,$$

to obtain a plurality of eigenvectors, a dimension of the obtained eigenvectors is irrelevant to the number Nr of receiving antenna ports.

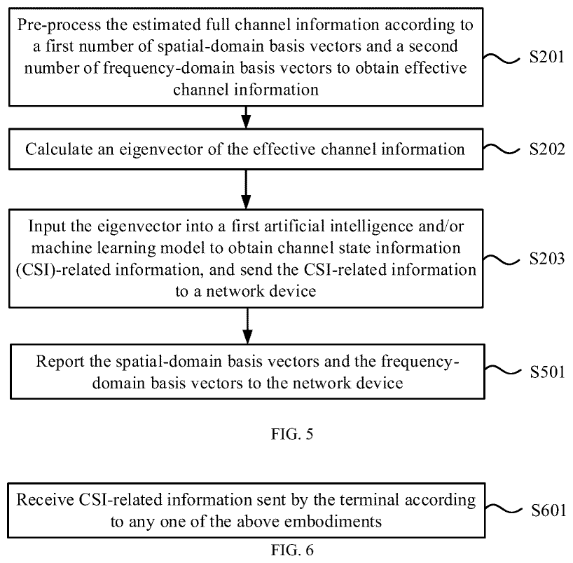

FIG. 5 is a schematic flowchart of another information sending method according to an embodiment of the present disclosure. As shown in FIG. 5, the method further includes following step.

In step S501, reporting the spatial-domain basis vectors and the frequency-domain basis vectors to the network device.

In an embodiment, the terminal may quantify and report the CSI-related information, and the network device may input the quantified CSI-related information into a second artificial intelligence and/or machine learning model (for example, the CSI recovery part model), to obtain recovery information of the estimated downlink full channel information, and then may construct the estimated downlink full channel information, and/or an eigenvector of channel information, and/or precoding for downlink data transmission based on the recovery information, the frequency-domain basis vectors, and the spatial-domain basis vectors.

That is, the network device constructs (which may be referred to as recover) the estimated downlink full channel information, which needs to be implemented based on the spatial-domain basis vectors and the frequency-domain basis vectors. Thus, the terminal can report the spatial-domain basis vectors and the frequency-domain basis vectors to the network device for use.

In an embodiment, reporting the spatial-domain basis vectors and the frequency-domain basis vectors to the network device includes: reporting the spatial-domain basis vectors and the frequency-domain basis vectors to the network device separately; or reporting the spatial-domain basis vectors and the frequency-domain basis vectors to the network device collectively.

There may be two manners for reporting the spatial-domain basis vectors and the frequency-domain basis vectors.

One of the manners is to report the spatial-domain basis vectors and the frequency-domain basis vectors separately, for example, report the spatial-domain basis vector and the frequency-domain basis vector as two independent values, or report indexes respectively corresponding to the spatial-domain basis vector and the frequency-domain basis vector.

Another one of the manners is to report the spatial-domain basis vectors and the frequency-domain basis vectors collectively, for example, pairs of the spatial-domain basis vectors and the frequency-domain basis vectors may be reported, for example, the spatial-domain basis vectors and the frequency-domain basis vectors may be reported in a form of a tensor product, for example, when the spatial-domain basis vector is denoted as f, and the frequency-domain basis vector is denoted as s, f⊗s can be reported, where ⊗ represents tensor product.

In an embodiment, reporting the spatial-domain basis vectors and the frequency-domain basis vectors to the network device includes: in response to determining that a type of the spatial-domain basis vectors is an eigenvector, quantifying a real part and an imaginary part of each of the spatial-domain basis vectors respectively and reporting to the network device; or in response to determining that a type of the frequency-domain basis vectors is an eigenvector, quantifying a real part and an imaginary part of each of the frequency-domain basis vectors respectively and reporting to the network device.

When the type of the spatial-domain basis vectors is an eigenvector, each spatial-domain basis vector may be represented in a form of a complex number, where the complex number includes a real part and an imaginary part. To facilitate quantification, the real part and the imaginary part may be quantified separately and reported to the network device. Similarly, when the type of the frequency-domain basis vectors is an eigenvector, each frequency-domain basis vector may be represented in a form of a complex number, where the complex number includes a real part and an imaginary part. To facilitate quantification, the real part and the imaginary part may be quantified separately and reported to the network device.

In an embodiment, reporting the spatial-domain basis vectors and the frequency-domain basis vectors to the network device includes: representing the spatial-domain basis vectors, or the frequency-domain basis vectors, or both, as a linear combination of orthogonal basis vectors and coefficients corresponding to the orthogonal basis vectors; and reporting the coefficients corresponding to the orthogonal basis vectors to the network device.

The spatial-domain basis vectors and/or the frequency-domain basis vectors may be represented as a linear combination of a plurality of orthogonal basis vectors and coefficients corresponding to the plurality of orthogonal basis vectors, where both the terminal and the network device may be able to know a manner for linear combination representation, that is, the network device may determine how the terminal represents the spatial-domain basis vectors and/or the frequency-domain basis vectors as linear combinations of a plurality of orthogonal basis vectors and coefficients corresponding to the plurality of orthogonal basis vectors. As the orthogonal basis vectors are relatively fixed in the linear combination, only the coefficients corresponding to the plurality of orthogonal basis vectors need to be reported to the network device.

It should be noted that a processing manner for the spatial-domain basis vectors and the frequency-domain basis vectors in a reporting process is not limited to the embodiments, for example, an amplitude value and a phase value of each element in the spatial-domain basis vectors may be determined, and then the amplitude value and the phase value of each element in the spatial-domain basis vectors are quantified separately and then reported to the network device; and correspondingly, an amplitude value and a phase value of each element in the frequency-domain basis vectors may be determined, and then the amplitude value and the phase value of each element in the frequency-domain basis vectors are quantified separately and then reported to the network device.

In an embodiment, the effective channel information includes at least one of: eigenvectors of one or more of data transmission layers obtained by pre-processing the estimated downlink full channel information according to the first number of the spatial-domain basis vectors and the second number of the frequency-domain basis vectors; or channel information of one or more of receiving antenna ports obtained by pre-processing the estimated downlink full channel information according to the first number of the spatial-domain basis vectors and the second number of the frequency-domain basis vectors.

The effective channel information obtained by pre-processing the estimated downlink full channel information by using the first number of spatial-domain basis vectors and the second number of frequency-0domain basis vectors may be an eigenvector of one or more data transmission layers in eigenvectors of a plurality of data transmission layers, for example, an eigenvector of a layer with rank=v, or may be channel information of one or more receiving antenna ports in channel information of a plurality of receiving antenna ports, for example, channel information of an r-th antenna port in Nr antenna ports, or channel information of all Nr antenna ports.

In an embodiment, a number of dimensions of the effective channel information is determined based on at least one of: the first number and the second number; a number of pairs of the spatial-domain basis vectors and the frequency-domain basis vectors; or a number of receiving antenna ports.

For example, the number of dimensions of the effective channel information may be twice of the product of the number of receiving antenna ports, the first number and the second number.

In an embodiment, the first number and the second number are determined based on at least one of: the first number configured by the network device; the second number configured by the network device; a sum of the first number and the second number configured by the network device; a product of the first number and the second number configured by the network device; or downlink channel information.

The network device may directly configure the first number and the second number for the terminal; or may configure the sum or the product of the first number and the second number for the terminal; or the terminal may determine the first number or the second number by itself, and then determine the second number or the first number based on the sum or the product of the first number and the second number configured by the network device, for example, the network device configures the sum of the first number and the second number, and after determining the first number, the terminal may determine that the second number is equal to the sum configured by the network device minus the first number; or the terminal may determine the first number and the second number by monitoring downlink channel information, for example, when downlink channel quality is determined to be relatively good based on the downlink channel information, and then the first number and/or the second number may be relatively small, for example, when downlink channel quality is determined to be relatively poor based on the downlink channel information, and then the first number and/or the second number may be relatively large.

A person skilled in the art may understand that the multiple embodiments performed by the terminal may be separately implemented, or may be implemented in any manner, which is not limited by the embodiments of the present disclosure.

FIG. 6 is a schematic flowchart of an information receiving method according to an embodiment of the present disclosure. The information receiving method shown in this embodiment may be performed by a network device, the network device may communicate with a terminal, the network device includes but is not limited to a base station in a communication system such as a 4G base station, a 5G base station, and a 6G base station, and the terminal includes but is not limited to a communication apparatus such as a mobile phone, a tablet computer, a wearable device, a sensor, and an Internet of Things device.

As shown in FIG. 6, the information receiving method may include following step.

In step S601, receiving CSI-related information sent by the terminal according to any one of the embodiments.

In an embodiment, the method further includes: inputting the CSI-related information into a second artificial intelligence and/or machine learning model to obtain recovery information of estimated downlink full channel information; and constructing at least one of the estimated downlink full channel information, an eigenvector of channel information, or precoding for downlink data transmission, according to the recovery information, the frequency-domain basis vectors, and the spatial-domain basis vectors.

For example, when the terminal communicates by using a dual-polarized antenna, the first number is L=4, the second number is M=4, and the number of receiving antenna ports is Nr=2, a dimension of the effective channel information is equal to 2 times of a product of Nr and L and M, that is, 64. Further, an eigenvector of the effective channel information may be calculated, the eigenvector is input into a CSI generation part model for compression to generate 20 codewords, and 2-bit quantification may be performed on each codeword to obtain a 40-bit data flow, and the 40-bit data flow is sent to the network device.

The network device may input the received 40-bit data flow into a second artificial intelligence and/or machine learning model, for example, a CSI recovery part model, recover information similar to the eigenvector as recovery information, and then construct estimated downlink full channel information based on the frequency-domain basis vectors and the spatial-domain basis vectors, to determine the state of the downlink channel based on the estimated downlink full channel information. Certainly, a channel information eigenvector may also be constructed, for precoding of downlink data transmission.

In an embodiment, the spatial-domain basis vectors and the frequency-domain basis vectors include at least one of: the spatial-domain basis vectors and the frequency-domain basis vectors reported by the terminal when sending the CSI-related information; or the spatial-domain basis vectors and the frequency-domain basis vectors reported by the terminal in history.

The terminal may also report the spatial-domain basis vectors and the frequency-domain basis vectors to the network device when sending the CSI-related information (the quantified data flow), and the network device may construct the estimated downlink full channel information by using the spatial-domain basis vector and the frequency-domain basis vector reported by the terminal.

If the terminal does not report the spatial-domain basis vectors and the frequency-domain basis vectors to the network device when sending the CSI-related information (the quantified data flow), the network device may construct the estimated downlink full channel information by using the spatial-domain basis vectors and the frequency-domain basis vectors that are historically reported by the terminal.

Corresponding to the embodiments of the information sending method and the information receiving method, the present disclosure further provides embodiments of an information sending apparatus and an information receiving apparatus.

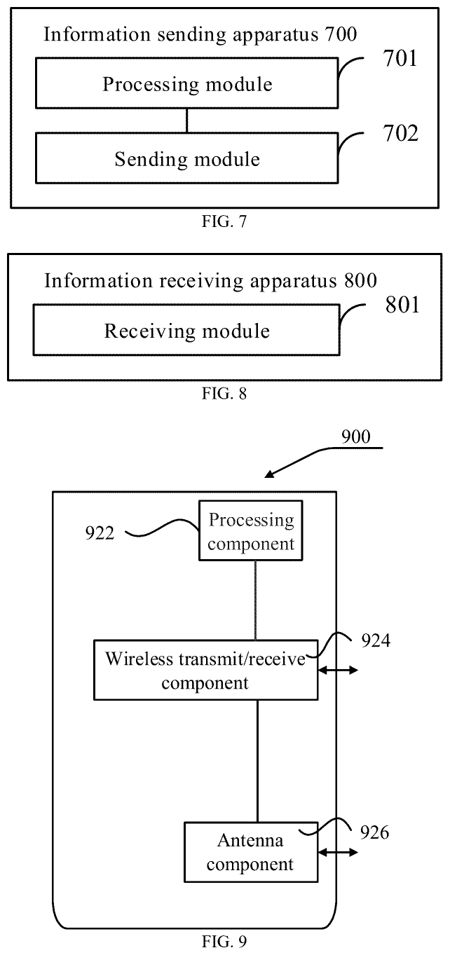

FIG. 7 is a schematic block diagram of an information sending apparatus according to an embodiment of the present disclosure. The information sending apparatus shown in this embodiment may be a terminal, or an apparatus formed by modules in a terminal, and the terminal includes but is not limited to a communication apparatus such as a mobile phone, a tablet computer, a wearable device, a sensor, and an Internet of Things device. The terminal may communicate with a network device, and the network device includes but is not limited to a network device such as a base station or a core network in a communication system such as 4G, 5G, and 6G.

As shown in FIG. 7, the information sending apparatus 700 includes a processing module 701 and a sending module 702.

The processing module 701 is configured to: pre-process estimated downlink full channel information according to a first number of spatial-domain basis vectors and a second number of frequency-domain basis vectors to obtain effective channel information; calculate an eigenvector of the effective channel information; and input the eigenvector into a first artificial intelligence and/or machine learning model to obtain channel state information (CSI)-related information.

The sending module 702 is configured to send the CSI-related information to a network device.

In an embodiment, the processing module 701 is further configured to determine current statistical downlink full channel information according to the current estimated downlink full channel information and historical statistical downlink full channel information; and perform eigenvalue decomposition according to the current statistical downlink full channel information, to obtain the first number of the spatial-domain basis vectors and the second number of the frequency-domain basis vectors; where a type of the spatial-domain basis vectors and the frequency-domain basis vectors is an eigenvector.

In an embodiment, the processing module 701 is further configured to: calculate the first number of the spatial-domain basis vectors and the second number of the frequency-domain basis vectors based on the estimated downlink full channel information, where a type of the spatial-domain basis vectors and the frequency-domain basis vectors is a discrete Fourier transform (DFT) basis vector.

In an embodiment, the sending module 702 is further configured to report the spatial-domain basis vectors and the frequency-domain basis vectors to the network device.

In an embodiment, the sending module 702 is configured to report the spatial-domain basis vectors and the frequency-domain basis vectors to the network device separately; and/or report the spatial-domain basis vectors and the frequency-domain basis vectors to the network device collectively.

In an embodiment, the sending module 702 is configured to: in response to determining that a type of the spatial-domain basis vectors is an eigenvector, quantify a real part and an imaginary part of each of the spatial-domain basis vectors respectively and reporting to the network device; and/or in response to determining that a type of the frequency-domain basis vectors is an eigenvector, quantify a real part and an imaginary part of each of the frequency-domain basis vectors respectively and reporting to the network device.

In an embodiment, the processing module 701 is configured to represent the spatial-domain basis vectors, or the frequency-domain basis vectors, or both, as a linear combination of orthogonal basis vectors and coefficients corresponding to the orthogonal basis vectors; the sending module is configured to report the coefficients corresponding to the orthogonal basis vectors to the network device.

In an embodiment, the effective channel information includes at least one of: eigenvectors of one or more of data transmission layers obtained by pre-processing the estimated downlink full channel information according to the first number of the spatial-domain basis vectors and the second number of the frequency-domain basis vectors; or channel information of one or more of receiving antenna ports obtained by pre-processing the estimated downlink full channel information according to the first number of the spatial-domain basis vectors and the second number of the frequency-domain basis vectors.

In an embodiment, a number of dimensions of the effective channel information is determined based on at least one of: the first number and the second number; a number of pairs of the spatial-domain basis vectors and the frequency-domain basis vectors; or a number of receiving antenna ports.

In one embodiment, the first number and the second number are determined based on at least one of: the first number configured by the network device; the second number configured by the network device; a sum of the first number and the second number configured by the network device; a product of the first number and the second number configured by the network device; or downlink channel information.

FIG. 8 is a schematic block diagram of an information receiving apparatus according to an embodiment of the present disclosure. The information receiving apparatus shown in this embodiment may be a network device or an apparatus including modules in a network device, and the network device may communicate with a terminal. The terminal includes, but is not limited to, a communication apparatus such as a mobile phone, a tablet computer, a wearable device, a sensor, and an Internet of Things device. The network device includes but is not limited to a network device such as a base station or a core network in a communication system such as 4G, 5G, and 6G.

As shown in FIG. 8, the information receiving apparatus 800 includes a receiving module 801.

The receiving module 801 is configured to receive CSI-related information sent by the terminal according to any one of the embodiments.

In an embodiment, the apparatus 800 further includes: a processing module (not shown), configured to input the CSI-related information into a second artificial intelligence and/or machine learning model to obtain recovery information of the estimated downlink full channel information; and constructing at least one of the estimated downlink full channel information, an eigenvector of channel information, or precoding for downlink data transmission, according to the recovery information, the frequency-domain basis vectors, and the spatial-domain basis vectors.

In an embodiment, the spatial-domain basis vectors and the frequency-domain basis vectors include at least one of: spatial-domain basis vectors and frequency-domain basis vectors reported by the terminal when sending the CSI-related information; and spatial-domain basis vectors and frequency-domain basis vectors historically reported by the terminal.

Regarding the apparatuses in the embodiments, a specific manner for each module to perform an operation has been described in detail in the embodiments related to the method, and will not be repeated in detail herein.

For the device embodiment, since it basically corresponds to the method embodiments, reference may be made to descriptions of the method embodiments. The apparatus embodiments described are merely illustrative, where the modules described as separate components may or may not be physically separate, and the components displayed as modules may or may not be physical modules, that is, may be located in one place, or may be distributed to multiple network modules. Some or all of the modules may be selected according to actual needs to achieve the objective of the solution of the embodiments. Those skilled in the art can understand and implement the present disclosure without making any creative work.

An embodiment of the present disclosure further provides an information transceiving system, including a terminal and a network device, where the terminal is configured to implement the information sending method according to any one of the embodiments, and the network device is configured to implement the information receiving method according to any one of the embodiments.

An embodiment of the present disclosure further provides a communication apparatus, including: a processor; and a memory configured to store a computer program, where the computer program, when executed by the processor, implements the information sending method according to any one of the embodiments.

An embodiment of the present disclosure further provides a communication apparatus, including: a processor; and a memory configured to store a computer program, where the computer program, when executed by the processor, implements the information receiving method according to any one of the embodiments.

An embodiment of the present disclosure further provides a non-transitory computer-readable storage medium, configured to store a computer program, where the computer program, when executed by a processor, implements the information sending method according to any one of the embodiments.

An embodiment of the present disclosure further provides a computer-readable storage medium, configured to store a computer program, where the computer program, when executed by a processor, implements the information receiving method according to any one of the embodiments.

As shown in FIG. 9, FIG. 9 is a schematic block diagram of an apparatus 900 for receiving information according to an embodiment of the present disclosure. The apparatus 900 may be provided as a base station. Referring to FIG. 9, the apparatus 900 includes a processing component 922, a wireless transmit/receive component 924, an antenna component 926, and a signal processing part specific to a wireless interface, and the processing component 922 may further include one or more processors (not shown). One of the processors in the processing component 922 may be configured to implement the information receiving method described in any one of the embodiments.

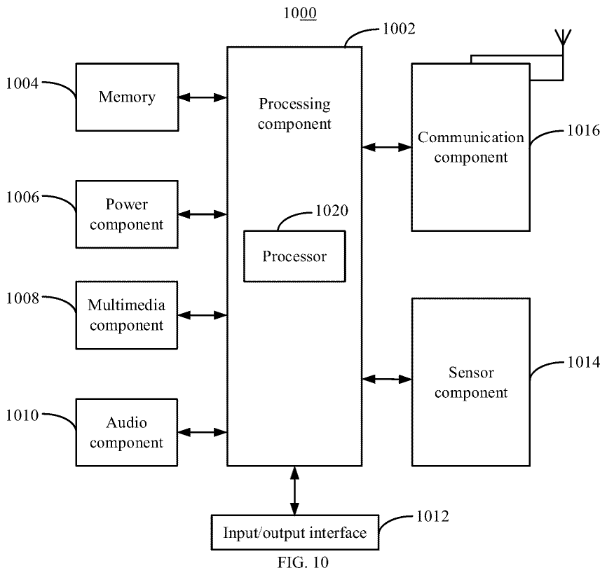

FIG. 10 is a schematic block diagram of an apparatus 1000 for sending information according to an embodiment of the present disclosure. For example, the apparatus 1000 may be a mobile phone, a computer, a digital broadcast terminal, a messaging device, a game console, a tablet device, a medical device, a fitness device, a personal digital assistant, or the like.

Referring to FIG. 10, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 generally controls overall operations of the apparatus 1000, such as operations associated with display, telephone calls, data communications, camera operations, and recording operations. The processing component 1002 may include one or more processors 1020 to execute instructions to perform all or part of the steps of the information sending method. In addition, the processing component 1002 may include one or more modules to facilitate interaction between the processing component 1002 and other components. For example, the processing component 1002 may include a multimedia module to facilitate interaction between the multimedia component 1008 and the processing component 1002.

The memory 1004 is configured to store various types of data to support operations at the apparatus 1000. Examples of such data include instructions for any application or method, contact data, phonebook data, messages, pictures, videos, etc., operating on the apparatus 1000. The memory 1004 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 1006 provides power to various components of the apparatus 1000. The power component 1006 may include a power management system, one or more power sources, and other components associated with generating, managing, and distributing power for the apparatus 1000.

The multimedia component 1008 includes a screen providing an output interface between the apparatus 1000 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 1008 includes a front camera and/or a rear camera. When the apparatus 1000 is in an operation mode, such as a photographing mode or a video mode, the front camera and/or the rear camera may receive external multimedia data. Each of the front camera and the rear camera may be a fixed optical lens system or have focal length and optical zoom capability.

The audio component 1010 is configured to output and/or input audio signals. For example, the audio component 1010 includes a microphone (MIC) configured to receive an external audio signal when the device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker configured to output an audio signal.

The I/O interface 1012 provides an interface between the processing component 1002 and peripheral interface modules, which may be keyboards, click wheels, buttons, etc. These buttons may include, but are not limited to, home buttons, volume buttons, start buttons, and lock buttons.

The sensor component 1014 includes one or more sensors for providing status assessments of various aspects of the apparatus 1000. For example, the sensor component 1014 may detect an open/closed state of the apparatus 1000, relative positioning of components, such as a display and a keypad of the apparatus 1000, a position change of the apparatus 1000 or a component of the apparatus 1000, a presence or absence of user contact with the apparatus 1000, an orientation or acceleration/deceleration of the apparatus 1000, and a temperature change of the apparatus 1000. The sensor component 1014 may include a proximity sensor configured to detect the presence of nearby objects without requiring any physical contact. The sensor component 1014 may also include a light sensor, such as a CMOS or CCD image sensor, for use in imaging applications. In some embodiments, the sensor component 1014 may further include an acceleration sensor, a gyroscope sensor, a magnetic sensor, a pressure sensor, or a temperature sensor.

The communication component 1016 is configured to facilitate wired or wireless communication between the apparatus 1000 and other devices. The apparatus 1000 may access a wireless network based on a communication standard, such as WiFi, 2G, 3G, 4G LTE, 5G NR, or a combination thereof. In an example embodiment, the communication component 1016 receives a broadcast signal or broadcast related information from an external broadcast management system via a broadcast channel. In an example embodiment, the communication component 1016 further includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the apparatus 1000 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the information sending method.

In an example embodiment, there is further provided a non-transitory computer-readable storage medium including an instruction, such as a memory 1004 including the instruction, where the instruction is executable by a processor 1020 of the apparatus 1000 to perform the information sending method. For example, the non-transitory computer-readable storage medium may be a ROM (read-only memory), a RAM (random access memory), CD-ROM (compact disc read-only memory), magnetic tape, floppy disk, optical data storage device, or the like.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described and shown in the accompanying drawings, and various modifications and changes may be made without departing from the scope thereof. The scope of the present disclosure is limited only by the appended claims.

It should be noted that, in this specification, relational terms such as first and second are merely used to distinguish one entity or operation from another entity or operation, and do not necessarily require or imply that there is any such actual relationship or order between these entities or operations. The terms “including,” “comprising,” or any other variation thereof are intended to cover a non-exclusive inclusion, such that a process, method, article, or device that includes a series of elements includes not only those elements, but also other elements not explicitly listed, or elements inherent to such process, method, article, or device. Without more limitations, an element defined by the statement “including one” does not preclude the presence of another identical element in a process, method, article, or device that includes the element.

The method and apparatus provided by the embodiments of the present disclosure are described in detail, specific examples are applied herein to describe the principles and implementations of the present disclosure, and the description of the embodiments is only used to help understand the method and core idea of the present disclosure; meanwhile, for those of ordinary skill in the art, according to the idea of the present disclosure, there will be changes in the specific implementation and application scope, and in summary, the contents of the present disclosure should not be construed as limiting the present disclosure.

1. An information sending method, performed by a terminal, comprising:
pre-processing estimated downlink full channel information according to a first number of spatial-domain basis vectors and a second number of frequency-domain basis vectors to obtain effective channel information;
calculating an eigenvector of the effective channel information; and
inputting the eigenvector into at least one of a first artificial intelligence and/or machine learning model to obtain channel state information (CSI)-related information, and sending the CSI-related information to a network device.

2. The method according to claim 1 further comprises:
determining current statistical downlink full channel information according to the current estimated downlink full channel information and historical statistical downlink full channel information; and
performing eigenvalue decomposition according to the current statistical downlink full channel information, to obtain the first number of the spatial-domain basis vectors and the second number of the frequency-domain basis vectors, and
wherein a type of the spatial-domain basis vectors and the frequency-domain basis vectors is an eigenvector type.

3. The method according to claim 1 further comprises:
calculating the first number of the spatial-domain basis vectors and the second number of the frequency-domain basis vectors based on the estimated downlink full channel information, wherein a type of the spatial-domain basis vectors and the frequency-domain basis vectors is a discrete Fourier transform (DFT) basis vector type.

4. The method according to claim 1 further comprises:
reporting the spatial-domain basis vectors and the frequency-domain basis vectors to the network device.

5. The method according to claim 4, wherein reporting the spatial-domain basis vectors and the frequency-domain basis vectors to the network device comprises at least one of:
reporting the spatial-domain basis vectors and the frequency-domain basis vectors to the network device separately; or
reporting the spatial-domain basis vectors and the frequency-domain basis vectors to the network device collectively.

6. The method according to claim 4, wherein reporting the spatial-domain basis vectors and the frequency-domain basis vectors to the network device comprises at least one of:
in response to determining that a type of the spatial-domain basis vectors is an eigenvector type, quantifying a real part and an imaginary part of each of the spatial-domain basis vectors respectively and reporting to the network device; or
in response to determining that a type of the frequency-domain basis vectors is an eigenvector type, quantifying a real part and an imaginary part of each of the frequency-domain basis vectors respectively and reporting to the network device.

7. The method according to claim 4, wherein reporting the spatial-domain basis vectors and the frequency-domain basis vectors to the network device comprises at least one of:
representing the spatial-domain basis vectors, or the frequency-domain basis vectors, or both, as a linear combination of orthogonal basis vectors and coefficients corresponding to the orthogonal basis vectors; or
reporting the coefficients corresponding to the orthogonal basis vectors to the network device.

8. The method according to claim 1, wherein the effective channel information comprises at least one of:
eigenvectors of one or more of data transmission layers obtained by pre-processing the estimated downlink full channel information according to the first number of the spatial-domain basis vectors and the second number of the frequency-domain basis vectors; or
channel information of one or more of receiving antenna ports obtained by pre-processing the estimated downlink full channel information according to the first number of the spatial-domain basis vectors and the second number of the frequency-domain basis vectors.

9. The method according to claim 1, wherein a number of dimensions of the effective channel information is determined based on at least one of:
the first number and the second number;
a number of pairs of the spatial-domain basis vectors and the frequency-domain basis vectors; or
a number of receiving antenna ports.

10. The method according to claim 1, wherein the first number and the second number are determined based on at least one of:
the first number configured by the network device;
the second number configured by the network device;
a sum of the first number and the second number configured by the network device;
a product of the first number and the second number configured by the network device; or
downlink channel information.

11. An information receiving method, performed by a network device, comprising:
receiving channel state information (CSI)-related information sent by a terminal according to the method according to claim 1.

12. The method according to claim 11, wherein the method further comprises:
inputting the CSI-related information into a second artificial intelligence and/or machine learning model to obtain recovery information of estimated downlink full channel information; and
constructing at least one of the estimated downlink full channel information, an eigenvector of channel information, or precoding for downlink data transmission, according to the recovery information, the frequency-domain basis vectors, and the spatial-domain basis vectors.

13. The method according to claim 12, wherein the spatial-domain basis vectors and the frequency-domain basis vectors comprise at least one of:
the spatial-domain basis vectors and the frequency-domain basis vectors reported by the terminal when sending the CSI-related information; or
the spatial-domain basis vectors and the frequency-domain basis vectors reported by the terminal in history.

14-15. (canceled)

16. An information transceiving system, comprising:
a terminal; and
a network device,
wherein the terminal is configured to
pre-process estimated downlink full channel information according to a first number of spatial-domain basis vectors and a second number of frequency-domain basis vectors to obtain effective channel information,
calculate an eigenvector of the effective channel information, and
input the eigenvector into at least one of a first artificial intelligence or machine learning model to obtain channel state information (CSI)-related information, and sending the CSI-related information to a network device, and
wherein the network device is configured to implement the information receiving method according to claim 11.

17. A communication apparatus, comprising:
a processor; and
a memory for storing a computer program;
wherein when the computer program is executed by the processor, the information sending method according to claim 1 is implemented.

18. A communication apparatus, comprising:
a processor; and
a memory for storing a computer program;
wherein when the computer program is executed by the processor, the information receiving method according to claim 11 is implemented.

19. A non-transitory computer-readable storage medium, configured to store a computer program, wherein when the computer program is executed by a processor, the information sending method according to claim 1 is implemented.

20. A non-transitory computer-readable storage medium, configured to store a computer program, wherein when the computer program is executed by a processor, the information receiving method according to claim 11 is implemented.
